(19) United States
(12) Patent Application Publication
(10) Pub. No.: US 2025/0310658 A1
(43) Pub. Date: Oct. 2, 2025

(54) SIGNAL PROCESSING CIRCUIT, SIGNAL PROCESSING METHOD, AND PROGRAM

(71) Applicant: Sony Interactive Entertainment Inc., Tokyo (JP)

(72) Inventors: Masayoshi MIZUNO, Tokyo (JP); Kiyotsugu ARAI, Kanagawa (JP)

(73) Assignee: Sony Interactive Entertainment Inc., Tokyo (JP)

(21) Appl. No.: 19/106,238

(22) PCT Filed: Sep. 28, 2022
(86) PCT No.: PCT/JP2022/036235

§ 371 Date: Feb. 25, 2025

(51) Int. Cl. H04N 25/47; H04N 25/40

(52) U.S. Cl. CPC H04N 25/47; H04N 25/40

(57) ABSTRACT

There is provided a signal processing circuit for processing an event signal generated by an event-based vision sensor (EVS). The signal processing circuit includes a memory configured to store a program code, and a processor configured to perform an operation in accordance with the program code. In a case where a ratio of eigenvalues of a variance-covariance matrix regarding positions of the event signals generated in each of blocks that divide a detection region of the EVS exceeds a threshold value, the operation includes detecting a relation of association between the positions using a first method. In a case where the ratio of the eigenvalues does not exceed the threshold value, the operation includes detecting the relation of association between the positions using a second method different from the first method.

### TECHNICAL FIELD

The present invention relates to a signal processing circuit, a signal processing method, and a program.

### BACKGROUND ART

There is known an event-based vision sensor (EVS) in which pixels that detect changes in the intensity of incident light generate signals asynchronously with time. The EVS is also called an EDS (Event Driven Sensor), an event camera, or a DVS (Dynamic Vision Sensor), which includes a sensor array constituted by a sensor including light-receiving elements. An EVS 110 generates an event signal including a timestamp, sensor identification information, and luminance change polarity information when the sensor detects a change in the intensity of incident light, or more specifically when the sensor detects a change in the luminance on the surface of an object. The EVS is advantageous in that it can operate at low power and at high speed compared to a frame-type vision sensor that scans all pixels at predetermined intervals, or compared specifically to image sensors such as a CCD (Charge Coupled Device) and a CMOS (Complementary Metal Oxide Semiconductor). Techniques related to the EVS are described in PTL 1 and PTL 2.

### CITATION LIST

### Patent Literature

[PTL 1]
JP 2014-535098T
[PTL 2]
JP 2018-85725A

### SUMMARY

### Technical Problem

However, with findings accumulated based on the techniques used by the frame-type vison sensor for processing the signals generated by the vision sensor, the event signals generated by the EVS tend to be processed likewise in bitmap form, i.e., two-dimensionally. In this case, the event signals generated asynchronously with time are supplemented with redundant information when processed. This makes it difficult to take full advantage of the high-speed performance of the EVS.

It is therefore an object of the present invention to provide a signal processing circuit, a signal processing method, and a program capable of processing, at higher speed, the event signals generated by the EVS.

### Solution to Problem

According to one aspect of the present invention, there is provide a signal processing circuit for processing an event signal generated by an event-based vision sensor (EVS). The signal processing circuit includes a memory configured to store a program code, and a processor configured to perform an operation in accordance with the program code. In a case where a ratio of eigenvalues of a variance-covariance matrix regarding positions of the event signals generated in each of blocks that divide a detection region of the EVS exceeds a threshold value, the operation includes detecting a relation of association between the positions using a first method. In a case where the ratio of the eigenvalues does not exceed the threshold value, the operation includes detecting the relation of association between the positions using a second method different from the first method.

According to another aspect of the present invention, there is provided a signal processing method for processing an event signal generated by an event-based vision sensor (EVS). The signal processing method includes causing a processor to perform an operation in accordance with a program code stored in a memory. In a case where a ratio of eigenvalues of a variance-covariance matrix regarding positions of the event signals generated in each of blocks that divide a detection region of the EVS exceeds a threshold value, the operation includes detecting a relation of association between the positions using a first method. In a case where the ratio of the eigenvalues does not exceed the threshold value, the operation includes detecting the relation of association between the positions using a second method different from the first method.

According to a further aspect of the present invention, there is provided a program for processing an event signal generated by an event-based vision sensor (EVS). The program includes causing a processor to perform an operation. In a case where a ratio of eigenvalues of a variance-covariance matrix regarding positions of the event signals generated in each of blocks that divide a detection region of the EVS exceeds a threshold value, the operation includes detecting a relation of association between the positions using a first method. In a case where the ratio of the eigenvalues does not exceed the threshold value, the operation includes detecting the relation of association between the positions using a second method different from the first method.

### BRIEF DESCRIPTION OF DRAWINGS

FIG. 1 is a schematic view depicting the configuration of a signal processing circuit as one embodiment of the present invention.

FIG. 2 is a schematic view depicting examples of blocks and events.

FIG. 3 is a view explaining an example of detecting a line segment in the example of FIG. 1.

FIG. 4 is a set of views depicting distribution examples of event signal positions in a block.

FIG. 5 is a flowchart indicating an exemplary process for determining the method to detect a line segment in the example of FIG. 1.

FIG. 6 is a view explaining an example of processing using block line parameters (BLP).

### DESCRIPTION OF EMBODIMENT

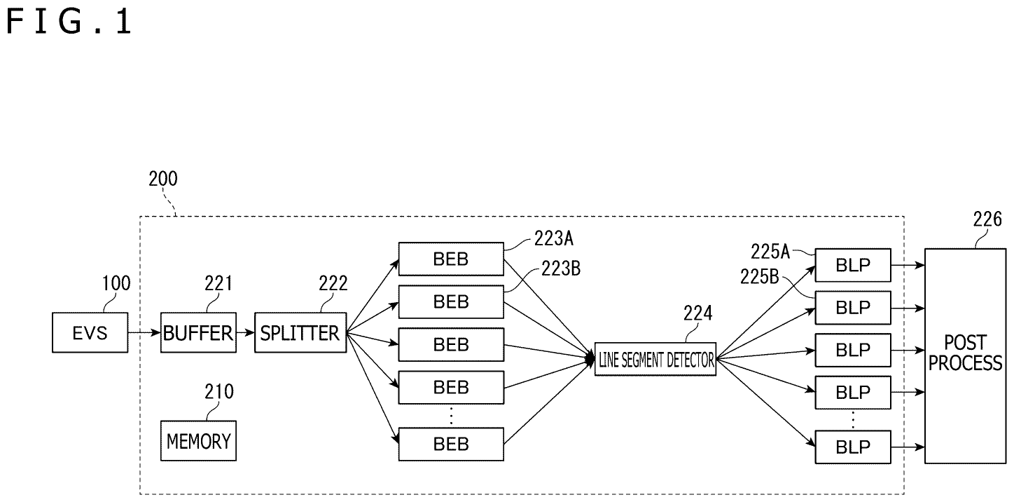

FIG. 1 is a schematic view depicting the configuration of a signal processing circuit as one embodiment of the present invention. A signal processing circuit 200 that processes event signals generated by an event-based vision sensor (EVS) 100 includes a processing circuit such as a CPU (Central Processing Unit), a DSP (Digital Signal Processor), an ASIC (Application Specific Integrated Circuit), and/or an FPGA (Field-Programmable Gate Array), for example. The signal processing circuit 200 includes a memory 210 including a ROM (Read Only Memory) and/or a RAM (Random Access Memory) of various types. The signal processing circuit 200 performs operations such as those discussed below in accordance with a program code stored in the memory 210. A post process 226 may be executed entirely or in part either by the signal processing circuit 200 or by an apparatus or a circuit different from the signal processing circuit 200.

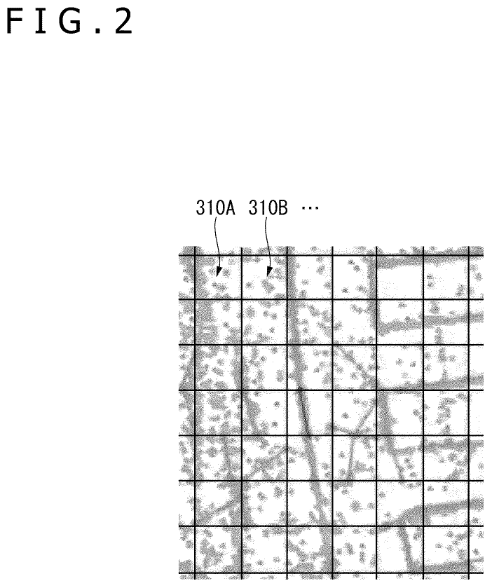

The event signals generated by the EVS 100 are held temporarily in a buffer 221 before being allotted to block event buffers (BEB) 223A, 223B, (also generically referred to as the BEB(s) 223 hereunder) by a splitter 222. Here, the splitter 222 allots the event signals generated in each of grid-like blocks 310A, 310B, . . . (also generically referred to as the block(s) 310 hereunder) to the corresponding BEBs 223A, 223B, . . . the blocks 310 dividing a detection region of the EVS 100 as illustrated in FIG. 2. The BEBs 223 are defined in advance as the buffers for holding the event signals corresponding to each of the grid-like blocks 310 dividing the detection region of the EVS 100. In the case where the settings of the blocks 310 are dynamically changed, as will be discussed in a subsequent example, the definitions of the BEBs 223 are also changed dynamically in accordance with the settings of the blocks 310. An event signal may include, for example, information regarding a position in x and y coordinates in the detection region, along with information regarding time t at which the signal was generated. The splitter 222 determines the BEB 223 to which to allot the event signal by referencing the information therein regarding the position in x and y coordinates. As will be discussed in the subsequent example, the splitter 222 may duplicate the event signal and allot the duplicated signals to two or more BEBs 223.

The BEB 223 holds the event signals generated in each block 310. When the event signals are allotted to one of the BEBS 223A, 223B, . . . , a line segment detector 224 detects a line segment from an aggregate of event signal positions in x and y coordinates in the BEB 223. That the line segment detector 224 of this embodiment detects a line segment provides an example in which a relation of association between the event signal positions in the block is detected. For example, in the case where events are generated by an edge of the object being moved in a given block 310, the aggregate of positions in x and y coordinates of the event signals forms a line segment. Although the edge of the object may not be linear, the object edge may be approximated as an aggregate of line segments when the grid-like block 310 is set to a suitable size. In this description, the “relation of association between event signal positions” indicates the data representing the event signal positions in the block in a manner of being smaller than in bitmap form. Therefore, the case of detecting the relation of association between the event signal positions in the block is not limited to examples in which a straight line or a line segment is to be detected. The examples in which a figure defined by a finite number of parameters is detected may thus be included.

As will be discussed later, the line segment detector 224 calculates eigenvalues of a variance-covariance matrix of an aggregate of event signal positions in x and y coordinates, and determines a method for detecting a line segment based on the calculated eigenvalues. For example, the line segment detector 224 detects the line segment using Hough transformation or by use of a method of minimizing the sum of distances from each of the event signal positions to the line segment. It is noted that a straight line detected directly by these methods is that of which the start point and end point are not specified. When the straight line is limited to within the block 310, a line segment corresponding to the straight line is detected. The line segment detector 224 may detect multiple line segments in one block 310.

More specifically, the line segment detector 224 outputs block line parameters (BLP) 225A, 225B, (also generically referred to as the BLP(s) 225 hereunder) indicating the detected line segment. The BLP 225A is information indicative of the line segment detected by the line segment detector 224 from the event signals that are generated in the block 310A and held in the BEB 223A. The same applies to the BLP 225B and subsequent BLPs. It is noted that the BLPs 225A, 225B, . . . may not necessarily be output synchronously, and the BLPs are output asynchronously in the process performed by the line segment detector 224 when the event signals are allotted to one of the BEBs 223. The BLP 225 thus output is utilized in the post process 226 as information indicative of the result of detection by the EVS 100. The post process 226 includes, for example, detection of the movement of a subject, three-dimensional matching of the subject, or processing by a recognizer using machine learning on the subject.

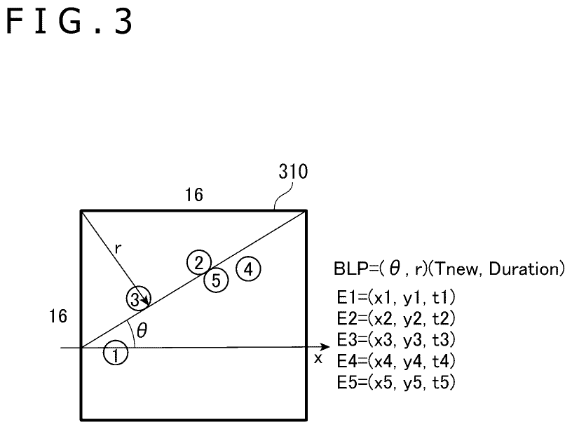

FIG. 3 is a view explaining an example of detecting a line segment in the example of FIG. 1. In this embodiment, as discussed above, when the event signals are allotted to the block event buffer (BEB) 223 corresponding to each of the grid-like blocks 310 dividing the detection region of the EVS 100, the line segment detector 224 performs the process of detecting a line segment from the aggregate of event signal positions in x and y coordinates. The example in FIG. 3 indicates a process in which the line segment is detected schematically from five event signals (there will be more or fewer event signals in practice) in the BEB 223. Event signals E1 to E5 may include information regarding event signal positions in x1 to x5 and y1 to y5 coordinates, respectively, in the detection region, along with information regarding times t1 to t5 at which the signals were generated. The positions in x1 to x5 and y1 to y5 coordinates each represent the position in the block 310 targeted for processing. For this reason, as long as the size of the block 310 is appropriate (16 by 16 pixels in the illustrated example), there is no need to put the event information in bitmap form. The line segment detector 224 can then mathematically detect a line segment from the positions in x1 to x5 and y1 to y5 coordinates of the event signals E1 to E5 held in the BEB 223.

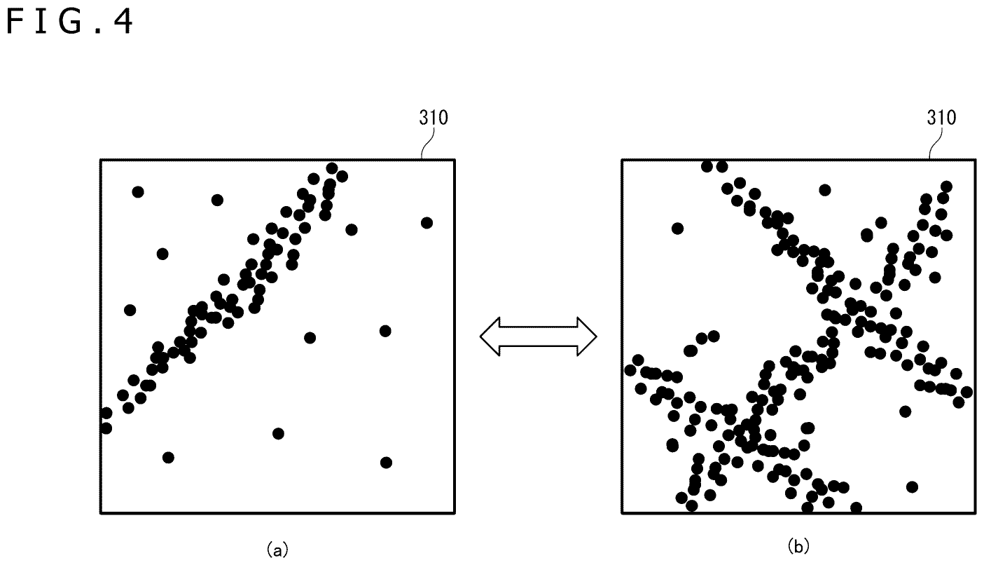

FIG. 4 is a set of views depicting distribution examples of event signal positions in a block. Depending on the shape of the object edge in the block 310, the event signals generated when the edge is moved may be distributed along a single straight line as depicted in FIG. 4 (a) or along multiple straight lines as illustrated in FIG. 4 (b), for example. Using Hough transformation, for example, can detect multiple straight lines from the event signal distribution such as one in FIG. 4 (b). On the other hand, Hough transformation may also be used to detect a single straight line as in the case of the event signal distribution in FIG. 4 (a). Still, a more simplified method, specifically the method of determining the straight line in a manner that the sum of distances from each of the event signal positions is minimized is used more advantageously from the viewpoint of speeding up calculations and economizing the processing resources of the signal processing circuit 200. The sum of distances from each of the event signal positions may be a sum of squares, an absolute sum, or a sum of the p-th power (p is an optional positive number), for example.

In this embodiment, the line segment detector 224 calculates the eigenvalues of the variance-covariance matrix of event signal positions. In the case where the ratio of the eigenvalues exceeds a threshold value, the line segment detector 224 detects the line segment by a first method. In the case where the ratio of the eigenvalues does not exceed the threshold value, the line segment detector 224 detects the line segment by a second method different from the first method. More specifically, as indicated below by a mathematical formula, the line segment detector 224 calculates a variance-covariance matrix S of an aggregate of event signal positions (xᵢ, yᵢ) (i=0, 2, . . . , N−1), and further calculates the ratio of the eigenvalues (λₘᵢₙ, λₘₐₓ) of the variance-covariance matrix S. It is noted that μx and μy represent the coordinates of the center of gravity of the event signal positions included in the aggregate.

$$\begin{matrix}\begin{matrix}S = {\sum }_{i = 0}^{N - 1} ( \begin{matrix}{x}_{t} - {μ}_{x} \\ yt - {μ}_{y}\end{matrix} ) ( \begin{matrix}{x}_{i} - {μ}_{x} & {y}_{i} - {μ}_{y}\end{matrix} ) \\ = ( \begin{matrix}{\sum }_{i = 0}^{N - 1} ( {x}_{i} - {μ}_{x} ) & {\sum }_{i = 0}^{N - 1} ( {x}_{i} - {μ}_{x} ) ( {y}_{i} - {μ}_{y} ) \\ {\sum }_{i = 0}^{N - 1} ( {x}_{i} - {μ}_{x} ) ( {y}_{i} - {μ}_{y} ) & {\sum }_{i = 0}^{N - 1} {( {y}_{i} - {μ}_{y} )}^{2}\end{matrix} ) \\ = ( \begin{matrix}{S}_{xx} & {S}_{xy} \\ {S}_{xy} & {S}_{yy}\end{matrix} )\end{matrix} \\ ratio = \frac{{λ}_{min}}{{λ}_{max}}\end{matrix} \qquad [ Math . 1 ]$$

The eigenvalues (Amin, Amax) are a positive value each. The ratio of the eigenvalues falls between 0 and 1. When the eigenvalue ratio is small, the event signal positions (xᵢ, yᵢ) are estimated to be distributed close to a single straight line. As a result, in the case where the ratio of the eigenvalues exceeds the threshold value, the line segment detector 224 detects the line segment using Hough transformation capable of detecting multiple straight lines. In other cases, the line segment detector 224 determines the line segment in a manner that the sum of distances from each of the event signal positions to the straight line is minimized. In this manner, the line segment detector 224 can detect multiple line segments and speed up the calculations using a simplified method where appropriate. This makes it possible to economize the processing resources of the signal processing circuit 200.

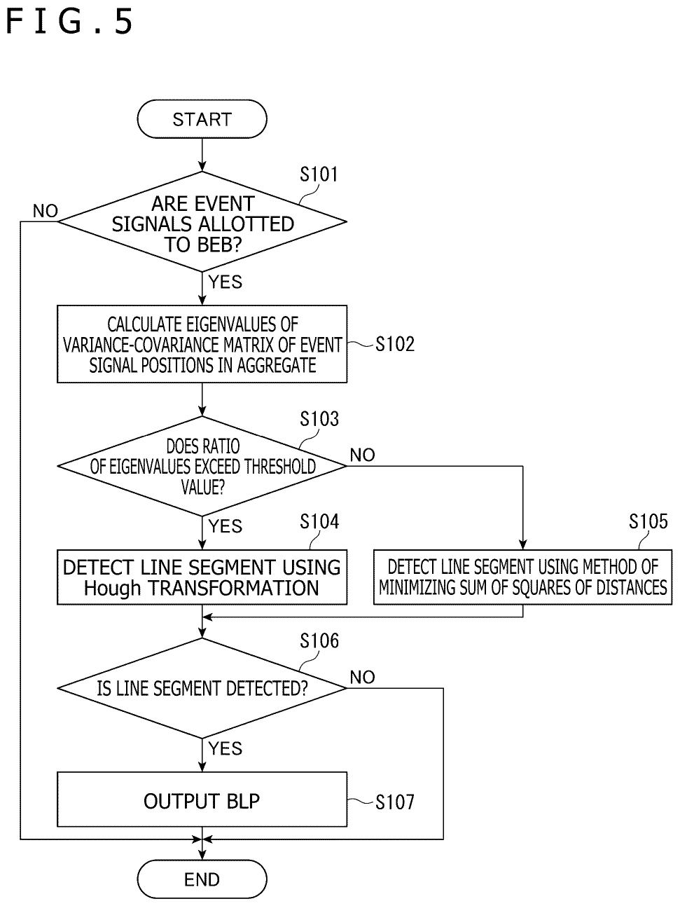

FIG. 5 is a flowchart indicating an exemplary process for determining the method to detect a line segment in the example of FIG. 1. As indicated in the flowchart, when an event signal is allotted to the block event buffer (BEB) 223 (step S101), the line segment detector 224 calculates the eigenvalues (λₘᵢₙ, λₘₐₓ) of a variance-covariance matrix S regarding an aggregate of event signal positions in x and y coordinates held in the BEB 223 (step S102). The line segment detector 224 then compares the eigenvalue ratio Amin/Amax with a predetermined threshold value. In the case where the eigenvalue ratio exceeds the predetermined threshold value (YES in step S103), the line segment detector 224 detects the line segment using Hough transformation (step S104). In other cases (NO in step S103), the line segment detector 224 detects the line segment by the method that minimizes the sum of distances from each of the event signal positions to the line segment (step S105). In the case where the line segment is detected either in step S104 or in step S105 (YES in step S106), the line segment detector 224 outputs a block line parameter (BLP) 225 indicative of one or multiple line segments that have been detected (step S107).

It is explained above that Hough transformation is used as an example of the first method in the case where the eigenvalue ratio exceeds the threshold value. Alternatively, some other suitable method may be used as long as the method is capable of detecting multiple straight lines. Likewise, it is explained above that the method of minimizing the sum of distances from each of the event signal positions is used as an example of the second method in the case where the eigenvalue ratio does not exceed the threshold value. However, the above example is not limitative of the second method if some other suitable method is capable of speeding up the calculations or economizing the processing resources of the signal processing circuit 200.

When the line segment detector 224 is to detect the line segment, an upper limit may be set on the number of event signals held in the BEB 223. The oldest event signal may then be deleted when a new event signal is allotted to the BEB 223 on a FIFO (first In, First Out) basis. Alternatively, a threshold value may be set as the difference between the time t of a given event signal and the processing time or the latest event signal time t. If the event signal exceeds the threshold value for the difference, then the event signal may not be used by the line segment detector 224 for line segment detection or may be deleted from the BEB 223.

In the case where an event signal of the same position in x and y coordinates as the position of the event signal currently held in the BEB 223 is newly allotted thereto, the time t of the currently held event signal may be updated with the time t of the new event signal so as to avoid duplication of the event signal of the same position in x and y coordinates in the BEB 223, for example. In this case, the calculations for detecting the line segment can be accelerated on the assumption that the event signals of the same position in x and y coordinates do not overlap with each other. Alternatively, multiple event signals of the same position in x and y coordinates at different times t may be held in the BEB 223.

In the example depicted in FIG. 3, the line segment detector 224 outputs the block line parameters (BLP) that include an angle (θ), a distance (r), the latest event time (Tnew), and an event duration time (Duration). The angle (θ) denotes the gradient of the line segment relative to the x axis. The distance (r) represents the distance from the top left corner of the block to the line signal (i.e., length of perpendicular line). However, this example is not limitative of some other suitable known method for identifying an optional line segment (e.g., using two parameters indicative of the gradient of the line segment and its position relative to the block). The latest event time (Tnew) is a time that corresponds to the most recent of the event signals used for line segment detection. For example, the latest event time (Tnew) may be identified by extracting the most recent of the event signals E1 to E5 at times t1 to t5 used for line segment detection (Tnew=t5 in the example of FIG. 3). Alternatively, since line segment detection is carried out when the most recent event signal is allotted to the BEB 232, the time at which the line segment detector 224 output the BLP 225 or the time at which the post process 226 received the BLP 225 may be set as the latest event time (Tnew) without reference to the times of the event signals E1 to E5.

The event duration time is the difference between the initial time and the last time from among the times t1 to t5 of the event signals E1 to E5 used for line segment detection (i.e., Duration=t5−t1 in the example of FIG. 3). From the information of the event duration time, it is possible to determine approximate times at which the event signals used for line segment detection were generated. For example, in the case where the event duration time is considerably long, it may be determined that numerous event signals detected as noise have been used for line segment detection so that the reliability of the line segment detected in the post process 226 is low. The line segment detector 224 may also output a variance Var[t] of the times at which the event signals were generated in time series. Here, in a case where the variance Var[t] is small despite a prolonged event duration time, the reliability of the detected line segment may be determined to be high in the post process 226. In the case where the event duration time is long and the variance Var[t] is large, the reliability of the detected line segment can be determined to be low.

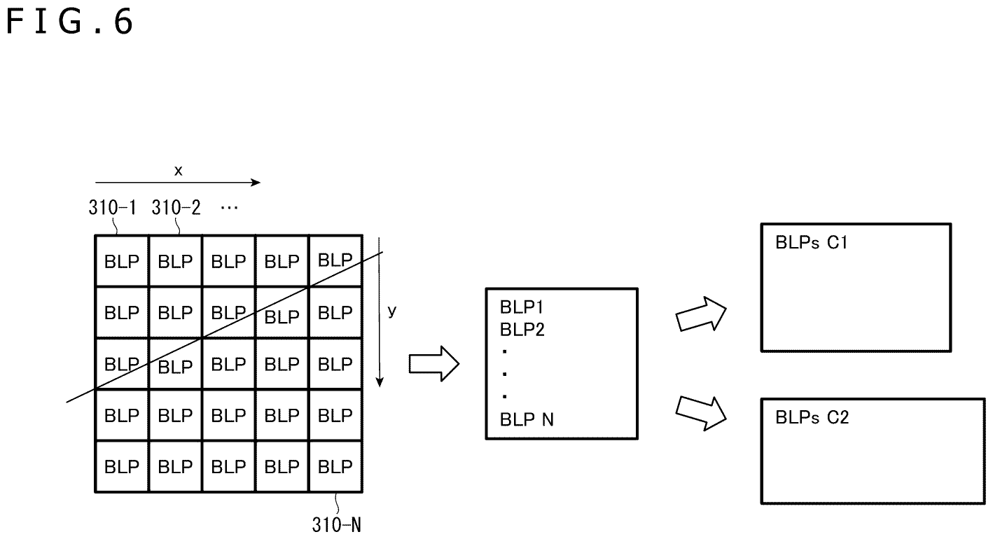

FIG. 6 is a view explaining an example of processing by use of block line parameters (BLP). In this embodiment, as discussed above, the BLP is output for each of the blocks 310 dividing the detection region of the EVS 100. For example, comparing BLP1 (A, t) output at time t in a block 310-1 with BLP1 (A, t−Δt) output previously in the same block 310-1 (previous to time t by Δt) makes it possible to calculate the movement and rotation of the line segment detected in the block 310-1. On the basis of these calculation results, the post process 226 sorts BLP1, BLP2, . . . , BLPN output in the blocks 310-1, 310-2, . . . , 310-N, respectively, into clusters by similarity in terms of moving and rotating directions. This makes it possible to identify BLP clusters (event line segment clusters) BLPsC1 and PLPsC2 in which a common line segment is estimated to be detected. On the basis of the BLPs sorted into the same event line segment cluster, it is possible to perform calculations such as affine transformation on a figure that spans multiple blocks. Whereas FIG. 6 indicates a straight line spanning multiple blocks, it is possible likewise to handle a curved line as an aggregate of line segments of which the gradient varies gradually from one block to another, for example.

This embodiment can utilize the results of the above-described processing for detection of movement of the subject, for three-dimensional matching of the subject, or for processing by a recognizer using machine learning on the subject in the post process 226, for example. The BLPs 225 are small in size compared to data in bitmap form of event signals, for example. The line segment expressed by the BLPs 225 can be handled as a highly accurate figure not constrained by the spatial resolution of the EVS 100. This makes it possible to perform rapidly and precisely the calculations such as affine transformation on the figures detected from the event signals.

### REFERENCE SIGNS LIST

100: EVS
200: Signal processing circuit
210: Memory
221: Buffer
222: Splitter
223: Block event buffer (BEB)
224: Line segment detector
225: Block line parameter (BLP)
226: Post process
310: Block
310-1, 310-2, 310A, 310B: Block

1. A signal processing circuit for processing an event signal generated by an event-based vision sensor (EVS), the signal processing circuit comprising:
a memory configured to store a program code; and
a processor configured to perform an operation in accordance with the program code, wherein,
in a case where a ratio of eigenvalues of a variance-covariance matrix regarding positions of the event signals generated in each of blocks that divide a detection region of the EVS exceeds a threshold value, the operation includes detecting a relation of association between the positions using a first method, and,
in a case where the ratio of the eigenvalues does not exceed the threshold value, the operation includes detecting the relation of association between the positions using a second method different from the first method.

2. The signal processing circuit according to claim 1, wherein the first method is Hough transformation.

3. The signal processing circuit according to claim 1, wherein
the relation of association includes a line segment formed by an aggregate of the positions, and
the second method includes determining a straight line corresponding to the line segment in a manner that a sum of distances from each of the positions to the line segment is minimized.

4. A signal processing method for processing an event signal generated by an event-based vision sensor (EVS), the signal processing method comprising:
causing a processor to perform an operation in accordance with a program code stored in a memory, wherein,
determining whether a ratio of eigenvalues of a variance-covariance matrix regarding positions of the event signals generated in each of blocks that divide a detection region of the EVS exceeds a threshold value;
in response to the ratio of eigenvalues exceeding the threshold value, the operation includes detecting a relation of association between the positions using a first method; and,
in response to the ratio of the eigenvalues not exceeding the threshold value, the operation includes detecting the relation of association between the positions using a second method different from the first method.

5. A program for processing an event signal generated by an event-based vision sensor (EVS), the program comprising:
causing a processor to perform an operation, wherein,
in a case where a ratio of eigenvalues of a variance-covariance matrix regarding positions of the event signals generated in each of blocks that divide a detection region of the EVS exceeds a threshold value, the operation includes detecting a relation of association between the positions using a first method, and,
in a case where the ratio of the eigenvalues does not exceed the threshold value, the operation includes detecting the relation of association between the positions using a second method different from the first method.

6. The program according to claim 5, wherein the first method is Hough transformation.

7. The program according to claim 5, wherein
the relation of association includes a line segment formed by an aggregate of the positions, and
the second method includes determining a straight line corresponding to the line segment in a manner that a sum of distances from each of the positions to the line segment is minimized.

8. The program according to claim 5, wherein the operation includes determining whether a line segment is detected by either the first or the second method, and, in response to the line segment being detected, outputting a block line parameter indicative of the line segment.

9. The program according to claim 8, wherein the operation includes outputting a block line parameter for each of blocks that divide the detection region.

10. The program according to claim 5, wherein the operation includes duplicating the event signal and allotting the duplicated event signal to two or more blocks.

11. The signal processing circuit according to claim 1, wherein the operation includes determining whether a line segment is detected by either the first or the second method, and, in response to the line segment being detected, outputting a block line parameter indicative of the line segment.

12. The signal processing circuit according to claim 11, wherein the operation includes outputting a block line parameter for each of blocks that divide the detection region.

13. The signal processing circuit according to claim 1, wherein the circuitry is configured to duplicate the event signal and allot the duplicated event signal to two or more blocks.

14. The signal processing method according to claim 4, wherein the first method is Hough transformation.

15. The signal processing method according to claim 4, wherein
the relation of association includes a line segment formed by an aggregate of the positions, and
the second method includes determining a straight line corresponding to the line segment in a manner that a sum of distances from each of the positions to the line segment is minimized.

16. The signal processing method according to claim 4, wherein the operation includes determining whether a line segment is detected by either the first or the second method, and, in response to the line segment being detected, outputting a block line parameter indicative of the line segment, and otherwise ending the operation.

17. The signal processing method according to claim 16, wherein the operation includes outputting a block line parameter for each of blocks that divide the detection region.

18. The signal processing method according to claim 4, wherein the operation includes duplicating the event signal and allotting the duplicated event signal to two or more blocks.
